(19) United States
(12) Patent Application Publication
(10) Pub. No.: US 2002/0194122 A1
(43) Pub. Date: Dec. 19, 2002

(54) Credit extension process using a prepaid card

(75) Inventors: David Knox, Point Roberts, WA (US); Josh Emanuel, Wayne, NJ (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: Datawave Systems, Inc., Vancouver (CA)

(21) Appl. No.: 10/085,820

(22) Filed: Feb. 26, 2002

Related U.S. Application Data
(63) Continuation-in-part of application No. 09/939,940, filed on Aug. 27, 2001.
(60) Provisional application No. 60/295,439, filed on Jun. 1, 2001.

(51) Int. Cl. G06F 17/60

(52) U.S. Cl. 705/39; 705/38

(57) ABSTRACT

A process determines whether a prepaid card customer is credit worthy by analyzing deposits and purchases transactions associated with the account of the customer. Credit is advanced on prepaid card purchases in response to the determination of creditworthiness. Prepaid card credit granting and repayment is made available other financial institutions for the establishment of more conventional credit. The prepaid card customer creditworthiness determination includes deposits and transactions made while the person was an anonymous prepaid card user. The process includes fraud and theft prevention measures including validation of the anonymous transactions using a biological identification such as a finger print or retinal scan or by validation of anonymous and non-anonymous deposit and purchase profiles. Alternatively, prepaid card credit can be granted even if the customer is anonymous and has not provided a validated name and other personal and/or financial information.

### CROSS REFERENCE TO RELATED APPLICATIONS

This is non-provisional application is a continuation-in-part on the patent application Ser. No. 09/939,940 [pending] to David Knox et al., for “Multiple denomination currency receiving and prepaid card dispensing method and apparatus” filed Aug. 27, 2001, which is commonly assigned herewith to DataWave Systems Inc, and is incorporated hereinto in its entirety by reference.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

1. Field of the Invention

The invention is generally related to the field of credit extension, particularly with respect to prepaid card customers.

2. Background of the Invention

The funding purchase transactions with credit cards has become widely accepted in our society. Nevertheless, a large number of purchase transactions are facilitated with cash. Cash has the advantage of allowing the purchaser to remain anonymous, thereby maintaining a purchaser's privacy. Still other purchasers are not deemed credit worthy and thus are not qualified to use credit cards. However, card based purchase transactions can be more convenient than cash because the need to physically carry cash is eliminated and the need to manually count cash at the time of purchase is also eliminated. Recent prepaid cash cards, such the prepaid cash card provided by DataWave System™, Inc., allow anonymous deposits and purchases with the convenience of a card based transaction. However, for those consumers deemed unworthy of credit, anonymous prepaid card transactions, while facilitating transaction convenience, do not facilitate establishment of credit worthiness.

Cash based transactions remain popular today for a variety of reasons. Many people are compensated in cash. This is because it is often too difficult to establish check or direct deposit based compensation. For example, waiters and waitresses may receive considerable tip compensation in the form of cash. Furthermore, some consumers may have no banking institution to handle direct deposit or check compensation, or may not be employed for a sufficient duration to merit establishment of check or direct deposit compensation, or may simply prefer cash compensation.

For consumers that receive cash compensation, the prepaid cash card provides a more convenient and secure method of consumer purchasing. The prepaid cash card customer simply deposits cash in an automated currency processor having an account associated with the card. Large sums of cash no longer need to be carried on their person, thereby providing a measure of security against loss or theft of their cash. Furthermore, one need not engage in the tedious and mistake prone counting of cash to make a purchase and subsequent counting of change received from the purchase. The amount of the purchase is automatically and accurately applied to an account balance by computerized accounting systems.

A number of cash compensated prepaid card customers may indeed be as credit worthy as others that receive pay check or direct deposit compensation.

However, the absence of a bank account or a record of deposit and spending history is often a considerable obstacle in establishing consumer credit for those receiving cash compensation. In the alternative, a number of prepaid card customers may have a bad prior credit history and desire to reestablish credit. Thus, what is needed is a way to extend credit to those receiving cash compensation without necessarily referring to prior credit performance. What is further needed is a way to establish a credit history for use by other creditors desiring to extend additional credit. It is also desirable to extend credit without demanding the loss of privacy facilitated by anonymous cash based transactions.

### BRIEF DESCRIPTION OF THE DRAWINGS

FIG. 1 shows a block diagram of a system operating in accordance with the present invention.

FIG. 2 shows a flow diagram of a process wherein a second financial institution facilitates a credit transaction based upon loan performance at a first financial institution wherein the credit rating for the loans is established by deposit and purchase transactions of a prepaid card customer.

FIG. 3 shows a flow diagram of a process for establishing credit after provision of personal information in accordance with the present invention.

FIG. 4 shows a flow diagram of a process for extending credit on the basis of account transactions in accordance with the present invention.

FIG. 5 shows a flow diagram of a process for validating anonymous deposits and purchases prior to provision of personal and credit information for the purpose of credit determination.

FIG. 6 shows an alternate process for credit extension and transaction validation based on the BIO-ID of the customer.

### DETAILED DESCRIPTION OF THE INVENTION

It is important to note, that these embodiments are only examples of the many advantageous uses of the innovative teachings herein. In general, statements made in the specification of the present application do not necessarily limit any of the equivalent and various claimed inventions. Moreover, some statements may apply to some inventive features but not to others. In general, unless otherwise indicated, singular elements may be in the plural and visa versa with no loss of generality.

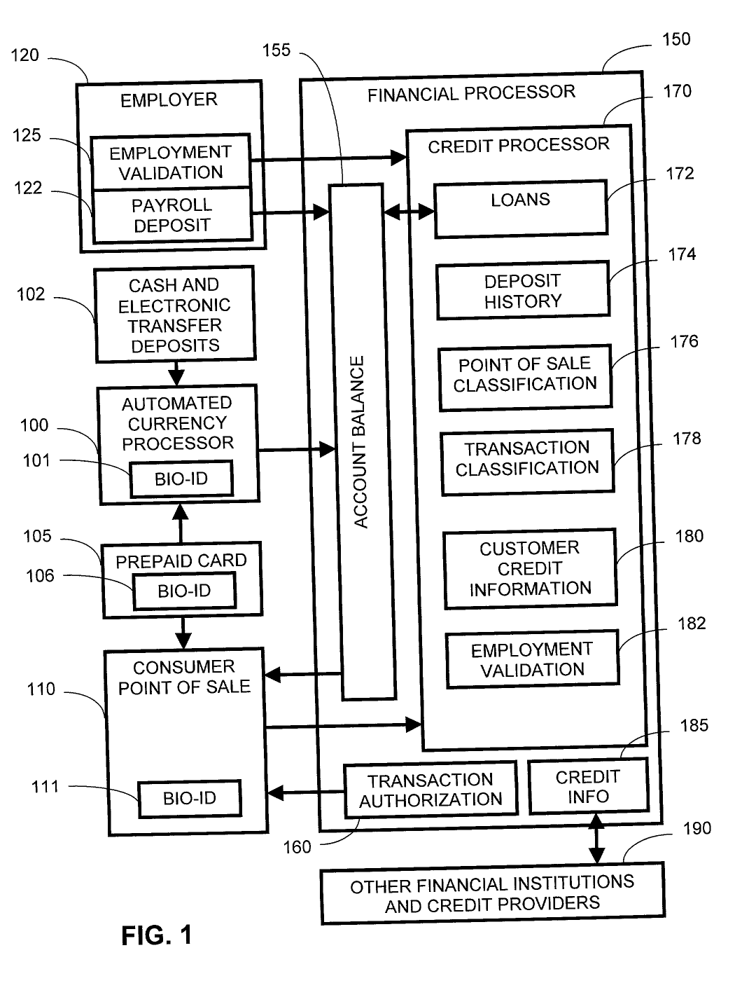

FIG. 1 shows a block diagram of a system operating in accordance with the present invention. A consumer may make deposits in an account using an automated currency processor 100, such as the automated currency processor described in U.S. patent application Ser. No. 09/939,940 of which is hereby incorporated by reference. The automated currency processor receives deposits 102, The deposits 102 include cash received in the form of paper or coin currency. The deposits 102 further include other electronic transfers such as those facilitated by credit card, prepaid card, smart card and other active or passive card transactions. The deposits from the automated currency processor are processed by a financial processor 150 which attributes the deposits to an account balance 155 associated with the customer. The customer preferably uses a prepaid card 105 to identify the account 155. The prepaid card may be any type of account card identifying account 155 including active smart cards and passive prepaid and credit cards. The consumer may use the prepaid card 105 to purchase goods or services from a consumer point of sale 110. The financial processor receives a transaction request from the consumer point of sale 110 and attributes it to account 155 with information provided by prepaid card 105. Additional transaction verification may be done by entry of a PIN by the customer or signature verification at point of sale 110. If the account balance 155 is sufficient to fund the transaction then the transaction is authorized by transaction authorization 160.

The aforementioned process allows for a customer to anonymously use a card at a point of sale to complete a transaction. No personal information is required to establish an account at the automated currency processor 100, and no personal information is required at consumer point of sale 110 to complete the transaction. Further, fund transfers into account 155 at the automated currency processor need not identify the customer. For example, funds can be transferred into the customer's account using a credit card of another at the automated currency processor. The credit card need not be the customer's credit card. For example, a prepaid card customer may perform a few hours of repair work and be compensated by the one employing the prepaid card customer. Instead of check or cash compensation, a credit card transfer of funds at the automated currency processor into the customer's account may be made by debiting the employer's credit card. Alternatively the transfer may occur over the Internet with a browser accessing the customer's account. See www.mycardstatus.com for an example an Internet based credit card transfer of funds into the account of a prepaid card.

If the prepaid card customer is regularly employed by an employer, then regular employer compensation or payroll deposit 122 may also be electronically transferred into the consumer's account 155. Methods and processes of such transfers are known to those familiar with the art. The employer may also provide automated employment validation information 125 to the financial processor.

Financial processor 150 further includes a credit processor 170. In the event that there are insufficient funds in account 155 to cover a transaction then credit processor 170 may nevertheless authorize the transaction on the basis of credit information by granting a loan 172. The credit processor determines a credit limit for the loan by using any of several types of information available to it. The credit processor processes several types of information including account deposit history 174, point of sale classification 176, transaction classification 178, consumer credit information 180 and employment validation 182. The credit processor may further produce credit information 185 which may be provided to other financial institutions or credit providers 190 facilitating establishing credit and facilitating credit based transactions at the other institutions 190. The credit information may include information regarding the credit performance of the customer as determined by the credit processor. For example if the credit processor grants a loan to the customer to facilitate a purchase transaction and the loan is repaid by subsequent deposits, then that loan information may be provided to Institutions 190. Institutions 190 may further provide additional credit information 180 for use by the credit processor 170.

It should be appreciated that the components of FIG. 1 including the automated currency processor 100, consumer point of sale 110, financial processor 150 and other institutions 190, are an illustration of the invention. In practice these components are part of a large and ever improving global financial network known to those familiar with the art. Preferably, decisions in authorizing transactions made by a financial processor 150 are preformed by the financial entity associated with the prepaid card 105, such as DataWave Systems Inc, a leading provider of prepaid cards. Other communication, network and equipment provision may be performed by a number other entities known to those familiar with the art.

The credit processor grants loans 172 to facilitate transactions. Loans are granted to an amount within a credit limit determined by the credit processor. Preferably the credit processor uses deposit, purchase and loan history to determine a credit limit. This more readily establishes a credit limit for customer deemed unworthy of conventional credit. The loan is repaid from funds deposited in the account. Prepaid card loan granting and repayment history is useful when a customer desires to establish credit with other financial institutions or credit providers.

The credit processor analyzes deposit history 174 of the account. For example, if the consumer has made monthly deposits of $500 for the past 12 months, then the regularity of the deposits may allow for extension of credit up to $250 in anticipation of the next deposit. If the deposits have been regular for the past four years then the amount could be increased to $600. Other values may be determined by statistical prediction and risk weighing methods known to those familiar with the art.

The credit processor analyzes point of sale classification 176. Since the customer could be anonymous, the extension of credit may only be made at certain types of points of sale wherein a point of sale has at least one distinguishing characteristic. For example credit could be extended at a pharmacy but not extended at a liquor store. Furthermore, credit may be established a neighborhood point of sale by determining locations of prior points of sale and comparing with the location of the current point of sale. Credit may not be extended if the point of sale is beyond the consumer's established neighborhood.

The credit processor analyzes the transaction classification 178. Transaction classification indicates the types of goods or services being purchased. Since the consumer could be anonymous, the extension of credit may only be made for certain types of goods or services. For example automotive repair services may merit extension of credit, while credit may not be extended for services at a casino. Further, credit may be extended for a class of goods or services regularly purchased by the consumer. For example, if the consumer has a history of purchasing nursing services, then credit could be extended for the continued purchase of nursing services, even though purchased at a new point of sale.

To further facilitate extension of credit, the consumer may decide to provide customer credit information. Customer credit information is known to those familiar with the art and includes personal identification information such as name and address. Furthermore tax ID number, bank account information, income sources and amounts, and other creditors and loans may be provided. Such information facilitates conventional establishment of credit which may be further used by the financial processor 170 to establish credit. For those deemed credit unworthy by conventional credit standards, other information regarding account transactions may be used by the credit processor to extend credit and authorize a transaction. For example if a customer has established a regular deposit and spending history then credit could be extended even though the customer has no permanent residence, verifiable income or bank account.

In another embodiment, if the customer had established the regular deposit and spending history while remaining anonymous, and the customer then provides personal information, the prior anonymous profile or history associated with the account could be attributed to the customer credit information for further establishing credit. The prior anonymous profile or history could further be made available to other institutions in the establishment of other types of credit such as a home mortgage loan.

In this embodiment, the anonymous prior history of the account 155 could be further validated by the continued habits of deposits, and classifications of transactions 178 points of sale 176 after the provision of consumer credit information 180. Since the prepaid card 105 associates the account with deposits and purchases when the customer is anonymous, validation of customer deposit and purchase behavior before and after provision of customer credit can be used as a measure against fraud. If the customer purchase classifications are substantially different after provision of the customer credit information, then less statistical weight should be given to the account history while the user was anonymous. In this example, the prepaid card may have been fraudulently or otherwise improperly obtained prior to the provision of the customer credit information.

This embodiment allows for the non-credit worthy consumer to remain anonymous while establishing a legitimate deposit, spending and loan history. The history may be made available to other financial credit institutions upon the provision of customer credit information. The anonymous history may be further validated by BIO-ID and/or sufficient deposit and point of sale and transaction classification after the provision of customer credit information.

The credit processor looks at employment validation 182. The credit processor queries the employer 120, or deposit transferring entity, to determine if the customer remains viably employed. The query is made by requesting employment validation information. Employment validation may further include a determination of the viability of the employer. For example, if the employer were to file bankruptcy or have other business problems clouding its viability then credit processor 170 would weigh that information in authorizing the transaction. Furthermore, if the customer where terminated by the employer, then credit would not likely be extended on the basis of payroll deposits 122 received from the employer.

The credit processor 170 uses loan history 172, deposit history 174, point of sale classification 176, transaction classification 178, customer credit information 180 and employment validation 182 in determining a credit score 185 and in authorizing the transaction 160. Credit performance information may be made available to other financial institutions and credit providers 190 such as Experian, Trans Union, Equifax and others known to those familiar with the art. Further, credit processor may obtain customer credit information 180 from institutions and providers 190. The credit score is a statistical calculation including at least a portion of the aforementioned factors and may be used to determine the likelihood that a loan will be repaid. There are many methods of statistically arriving at a precise credit score or credit rating, such statistical methods are known to those familiar with the art and include Beacon, FICO, and Empirica credit scores.

In an alternate embodiment, automated currency processor 100 and consumer point of sale 110 include BIO-IDs or biological identifier devices 101 and 111, respectively. The customer also includes a biological identifier 106 uniquely indicative of the customer. Biological identification techniques and devices are within the field of biometrics and are known to those familiar with the art and include finger print identification and/or retinal scans. Alternative identifiers include voice or image recognition and DNA sequence identification. The BIO-ID has the advantage of positively identifying the customer without necessarily requiring personal or customer credit information. This allows the customer to remain anonymous while providing an additional measure of fraud prevention. When an anonymous customer obtains a card from the automated currency processor with an initial cash deposit, the customer's BIO-ID is recorded at the automated currency processor. There is no requirement to obtain any other information identifying the customer. When a purchase is made at a consumer point of sale, the customer's BIO-ID is again determined and the transaction is authorized if the BIO-ID matches the BIO-ID received at the time of deposit. Note that matching BIO-IDs may be substantially similar so as to exclude a significant portion of the population by its use, thereby reducing the likelihood of theft or fraud. Furthermore, the customer may authorize others, such as family members, to access the account buy the use of BIO-IDs and/or prepaid cards. The use of the BIO-ID further protects the customer from unauthorized withdraws if the prepaid card is stolen. Furthermore, if there are insufficient funds, then analysis of prior deposit , spending and loan characteristics can be analyzed in order to determine if credit should be extended. Validation of the BIO-ID protects the credit provider from extension of credit to an anonymous person due to theft or fraudulent use of the card. This is because the credit provider reduces the risk of extending credit to another person who is not the anonymous customer who has established a deposit and spending history. Matching of the BIO-IDs assures the credit provider that the anonymous customer requesting transaction authorization is indeed the same anonymous customer who has established a deposit and spending profile. It should be further appreciated that in an alternate embodiment the prepaid card 105 could be entirely replaced by the BIO-ID. Thus, a customer's finger print, retinal image, voice, visual image or DNA sequence would be entirely sufficient to associate deposits, purchases and credit determinations with the corresponding account 155.

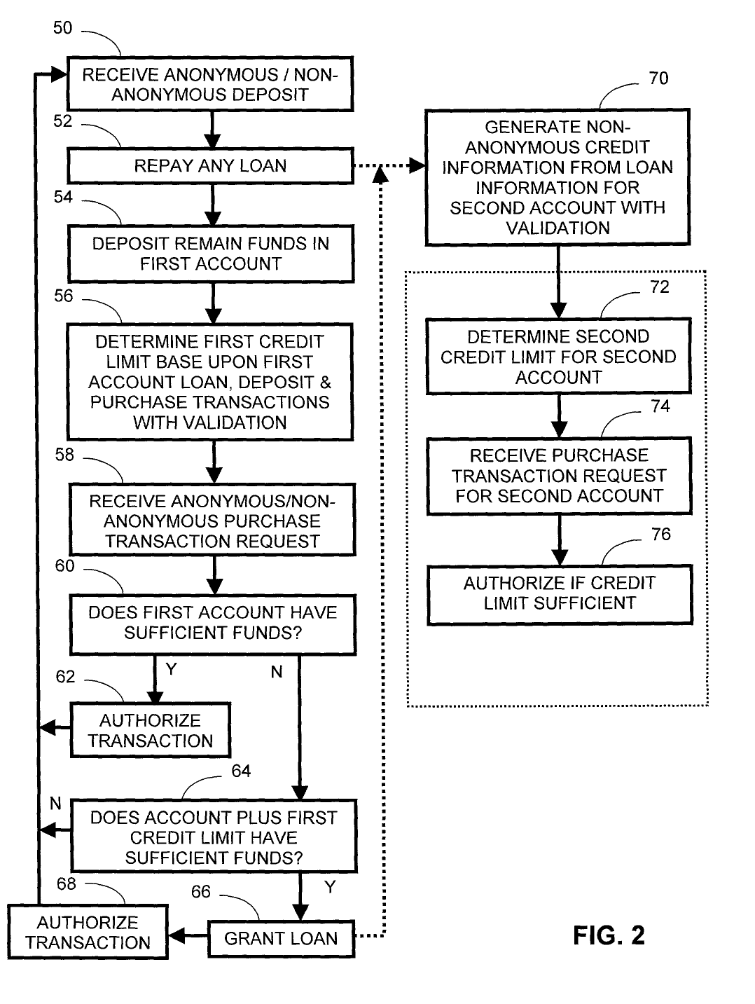

FIG. 2 shows a flow diagram of a process wherein a second financial institution facilitates a credit transaction based upon loan performance at a first financial institution wherein the credit rating for the loans is established by deposit and purchase transactions of a prepaid card customer. In step 50, deposits are received. The deposits are preferably non-anonymous or alternatively anonymous depending on whether or not the customer associated with the account has provided personal information identifying the customer. The deposit may be a cash deposit at the automated currency processor, or other electronic fund transfer. Then is step 52 any loan granted (from step 66) is repaid (either settled or paid down depending upon the amount deposited, the minimum payment and/or directions from the customer) from the deposit and the remaining funds transferred into a first account. The first account is preferably a prepaid card account established by the customer. Then in step 56 a credit limit is determined based upon the account deposit, purchase and loan transactions. Preferably, the credit limit is determined only if the customer has provided personal information identifying the customer. The personal information includes name and address information but preferably does not include other financially related information such as bank account, loan and credit status or property ownership information. In another embodiment, if the customer's prepaid card account was initially established as anonymous and then personal information provided some time thereafter, the anonymous deposits and purchases can be used in determining the first credit limit upon validation. Several methods of validation are described below. In yet another embodiment the customer's credit limit may be established even if the customer is anonymous, as described in more detail below. Then is step 58, a purchase transaction request is received. The request may be either anonymous or non-anonymous depending upon whether the customer as provided personal information. Step 60 determines if the first account has sufficient funds. If so, then the transaction is authorized in step 62 thereby facilitating the purchase. If there are not sufficient funds then step 64 determines if the credit limit is sufficient to cover the transaction. If not, no authorization is generated. If so, then a loan is granted at step 66 equivalent to the amount beyond the account balance needed to facilitate the transaction and the transaction authorized at step 68. The granting of the loan may invoke additional charges such as loan origination and interest fees. The loan granting at step 66 and loan repayment of step 52 are useful in the establishing of credit beyond the first credit limit determined by the prepaid card company hosting the first account. Step 70 generates non-anonymous credit information from the loan information for use by other financial institutions for extension of credit to the customer. This credit information is non-anonymous when identification of personal information related to the customer is required by the other financial institutions in the extension of credit. Since the extension of credit at step 56 may have occurred while the customer was anonymous, the loan granting and repayments may be further validated as described below. Steps 72-74 are preferably performed by a separate financial institution or credit agency. Step 72 determines a second credit limit for a second account based in part on the loan granting and repayments of the first account at steps 66 and 52. Other conventional credit information may be processed such as bank assets and other credit performance and other tangible or intangible assets and incomes. In step 74 a purchase request for the second account is received. If there is sufficient credit limit then the transaction is authorized at step 76.

FIG. 2 show a process wherein a customer may anonymously open a first account using cash deposits at an automated currency processor and use a prepaid card to facilitate anonymous purchases. A prepaid card credit limit is established based upon a history of deposit, purchase and loan transactions facilitated by the financial processor. No other credit information is required. This has the advantage of providing credit to customers who may be unworthy of credit by conventional standards by utilizing a history of prepaid card transactions that would have otherwise been facilitated with cash. When the customer uses the prepaid card credit, loan granting and loan repayment by subsequent deposits results. The loans and loan repayment history is useful and is used by another financial institution to extend other types credit to the customer for other purchasers. The customer provides personal information prior to the extension of credit by the second financial institution, thereby making all subsequent deposit, purchase and loan transactions non-anonymous. The process has the further advantage of validation steps which allow use of the prior anonymous transactions in the determination of credit limits. Thus, the transaction history developed while the customer was anonymous remains applicable.

A further advantage of the invention is the ability to provide the prepaid card customer with advance information regarding how credit can be established with the prepaid card provider. Schedules including time tables and deposit amounts leading to credit amounts may be provided to the customer at any time. This allows a customer with no credit history or bad credit history to meet known expectations in the provision of credit. Table 1 below is an example of a table that would be provided to a customer indicating predetermined criterion of deposit characteristic for the provisions of credit.

TABLE 1
DEPOSIT HISTORY AND CREDIT PROVIDED

| WEEKLY DEPOSIT | WEEKS 0-27 | WEEKS 26-51 | WEEKS 52-104 |
|---|---|---|---|
| $100 | CREDIT = $0 | CREDIT = $0 | CREDIT = $100 |
| | | | MINIMUM WEEKLY |
| | | | DEPOSIT = 25% |
| | | | OF CREDIT |
| $500 | CREDIT = $0 | CREDIT = $300 | CREDIT = $600 |
| | | MINIMUM WEEKLY | MINIMUM WEEKLY |
| | | PAYMENT = 25% | PAYMENT = 10% |
| | | OF CREDIT | OF CREDIT |

For example, if a customer makes weekly deposits of $500 for twenty six weeks, then a credit of $300 is available for the prepaid card customer. Prior to the completion of the 26 weeks it is anticipated that the customer is purchasing goods or services at points of sale at a rate substantially equal to the deposit rate. Thus, a typical prepaid card customer depositing $500 a week is also spending about $500 a week with the prepaid card. After credit is advanced between weeks 26 and 51, the minimum weekly payment is 25% of the loan granted. Thus, if a customer receives a $300 loan, the next minimum weekly deposit is $75. If this deposit is not made then a missed loan payment may be reported to other institutions. If this deposit is made then a satisfactory loan payment may be reported to other institutions. In order to advance to the next credit level, the next total deposit after the $300 loan must be at least $575, equal to the weekly deposit of $500 plus the minimum weekly payment of $75. The customer may direct that the deposit includes more than the minimum weekly payment of credit. For example, if the customer's weekly deposit were $650 instead of $575 then the customer could direct that $100 be applied to loan repayment (rather than the $75 minimum) and the remaining $550 be deposited in the account. This example works not only to accelerate loan repayment but accelerates the customer's building of credit available with the prepaid card. The customer's direction may be made at the time of deposit, via instructions over the internet or at other times or means as are known by those familiar with the art. If this the loan is entirely repaid then both the periodic loan payments and a satisfactory loan repayment may be reported to other institutions. If the customer continues to deposit $500 per week plus additional minimum weekly payment, then after 52 weeks the available credit is increased to $600 per month and the minimum weekly payment after credit is advanced is decreased to 10% of the credit advanced. This reflects the customer's improved creditworthiness. If the minimum weekly payment is not met, then a missed payment may be included in credit information provided to other financial institutions.

Providing a prepaid card customer with a predetermined deposit criterion has the advantage of allowing customers desiring to establish credit a clear and readily understood process to achieve their desired goal. Furthermore, the customer having a poor credit history and desiring to reestablish credit has the additional advantage of being able to establish credit with prepaid card purchases without having to disclose prior credit history. If the customer has good credit performance with the prepaid card, such information will be made available to other credit agencies or financial institutions thereby facilitating the further advancement of credit. An additional advantage is realized in that a prepaid customer desiring to establish credit is encouraged to use the prepaid card as much as possible in place of transactions that were formerly cash because the customer is encouraged to maximize deposits in order to maximize the resulting credit. Encouraging maximum use of the prepaid card has the further advantage of maximizing collected transaction fees associated with use of the prepaid card.

It should be appreciated that numerous variations of the above table are possible while remaining within the scope of the invention. For example, the weekly deposit can be computed as an average weekly deposit calculated over a desired time interval. The time interval, deposit amounts, credit amounts and minimum weekly payments may be varied in accordance with risk adjusted credit determination formulas. The customer may repay the loan at a rate faster than the rate provided by the minimum monthly payment. If a customer having received a loan of some or all of the credit limit makes only the minimum weekly payment and does not make the weekly deposit, then no additional credit may be provided until the weekly deposits are again made.

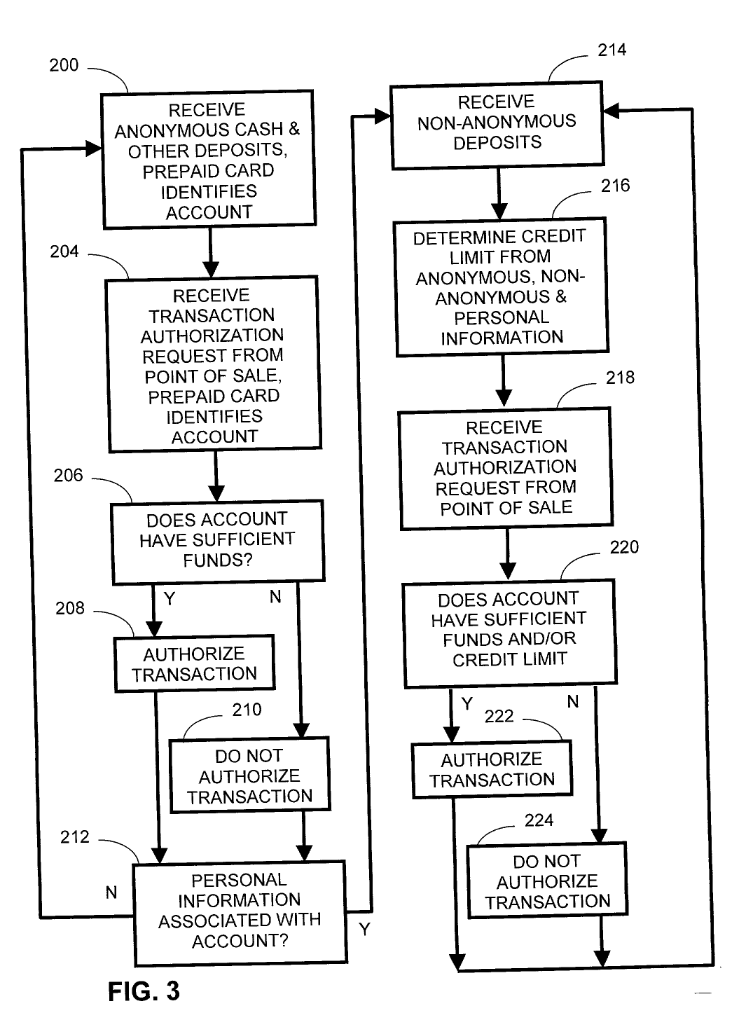

FIG. 3 shows a flow diagram of a process for establishing credit after provision of personal information in accordance with the present invention. Steps 200 through 212 show the transaction method when the customer is anonymous and no credit is extended while steps 214 through 224 show the transactions when the customer is no longer anonymous and credit may be extended. Note that in alternate embodiments credit can be extended while the customer remains anonymous. Step 200 receives anonymous cash and other deposits at a currency processor wherein information associated with the prepaid card identifies the account. For example, referring to table 1 above, the customer may be anonymous for the first 12 weeks and then provide personal information, making additional deposits thereafter. The initial 12 weeks of deposits may be considered in determination of credit. It should be appreciated that for non-cash transfers of step 200, that alternative devices and methods other than a currency processor may be used to facilitate the transfer. Such alternatives include conventional wire transfers and Internet based transactions. Step 204 receives a transaction authorization request from a point of sale wherein the prepaid card identifies the account. Step 206 determines if sufficient funds are available to cover the transaction. If so the transaction is authorized in step 208. Alternately, if there are insufficient funds then the transaction is not authorized in step 210. Corresponding account debiting and funds transfer to the point of sale merchant are not shown. Step 212 checks if personal information is associated with the account. The personal information includes customer credit information. If not, the process returns to step 200 and/or 204 to await for another deposit or purchase transaction. If personal information is received, then step 214 receives non-anonymous deposits. Deposits may be receive with information indicative of the account included on the prepaid card, or may be received with information indicative of the customer as included in the personal and credit information provided at step 212. Then, step 216 determines a credit limit based upon anonymous and non-anonymous purchases and deposits, and personal information including credit information. Step 218 receives a transaction authorization request from a point of sale. Step 220 determines if the sum of the credit limit and the account balance is sufficient to cover the transaction. Step 222 grants the loan and authorizes the transaction if the sum is sufficient, otherwise the transaction is not authorized at step 224. Corresponding account debiting and funds transfer to the point of sale merchant are not shown. It should be appreciated that the amount of credit may be modified based upon the classification of the point of sale requesting authorization or the classification of goods and/or services associated with the transaction request at step 218. Thereafter the process returns to steps 214 through 218 to receive deposits, transaction authorization requests and determine credit limits.

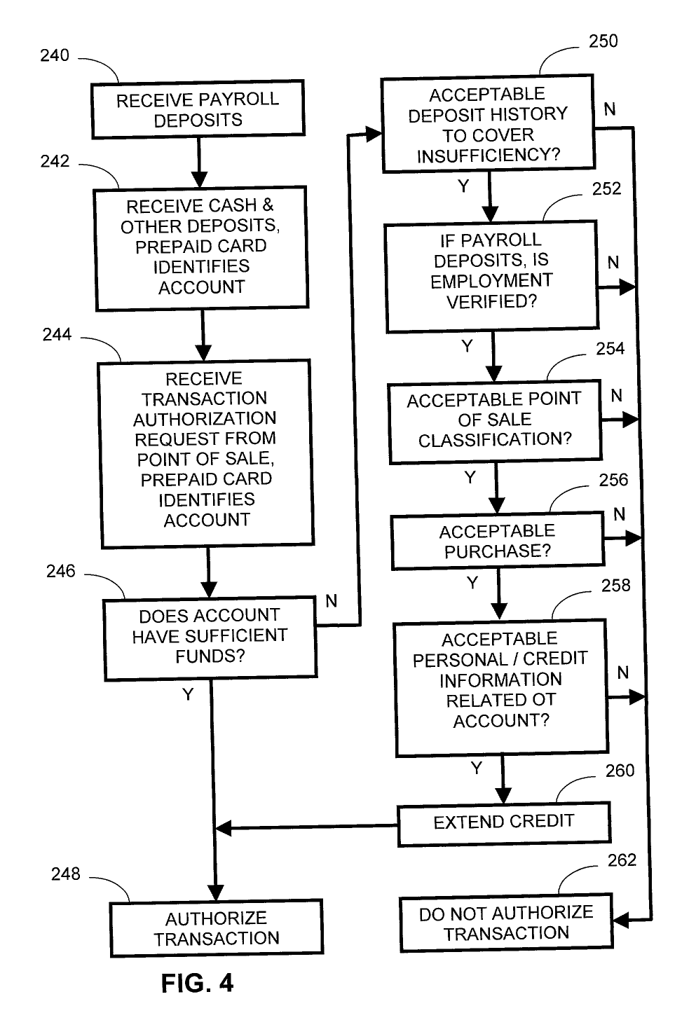

FIG. 4 shows a flow diagram of a process for extending credit on the basis of account transactions in accordance with the present invention. Payroll deposits are received at step 240, such deposits are optional. In step 242, cash and other deposits are received. Information included with the prepaid card associates cash and other deposits with the account. If the account is not anonymous, then personal and credit information may be used to direct the deposit to the account. A transaction authorization request is received from a point of sale at step 244 wherein the prepaid card is used to identify the account. The transaction is authorized if the account has sufficient funds, steps 246 and 248. If insufficient funds, steps 250 through 260 determine if credit should be extended. Step 250 determines if there is an acceptable deposit history to cover the insufficiency. For example credit may be extended up to the value of the next anticipated deposit. As a modification or alternative to the example of Table 1 above, a statistical example of determining how much credit to extend includes; extending no credit if deposits have not been regular for six months, extending credit equal to 10% of the next expected deposit upon the six month, linearly increasing to 50% of the next anticipated deposit through the twenty fourth month, and maintaining the credit limit to 50% of the next anticipated deposit thereafter. If the deposit is a payroll deposit, step 252 may further verify employment with the employer to assure the employee is still an employee and/or to ensure the viability of the employer. Such employment and employee checks may be automated. The credit is preferably adjusted to reflect the statistical risk of receiving the employer payroll deposit. Step 254 determines if the point of sale is acceptable. This step additionally determines credit based upon the aforementioned classification associated with the point of sale. For example, if the point of sale is a liquor store, then credit may be denied or reduced by a factor associated with the classification. Step 256 determines if the goods and/or services to be purchased are acceptable. This step additionally determines credit based upon the aforementioned classification associated with the goods and/or services being purchased. For example, if purchasing services in a casino is attempted, then credit beyond the amount deposited in the account may be denied or reduced by a factor associated with the classification. It should be appreciated that weekly deposits of Table 1 may be enhanced or substituted with weekly purchase information. This has the additional advantage of being able to determine a credit limit further in response to an assign a credit quality factor associated with the points of sale used by the prepaid card customer. Step 258 determines if the personal and/or credit information related to the account is acceptable. This applies to more conventional credit establishment processes based on customer supplied information and/or information provided by financial institutions and credit providers. This step may substantially modify the amount of credit determined by the prior steps. For example, if the customer is anonymous then the credit extended may be reduced. However, if it is known that the customer has substantial assets and/or deposits at a bank or other financial institution, then credit may be greatly increased. If the extended credit of step 260 plus the account balance is sufficient to cover the transaction, then it is authorized at step 248 and a loan granted. Otherwise the transaction is not authorized at step 262.

It should be appreciated that the financial processor may make a credit determination by performing steps 250 through steps 258 and provide that information to other financial institutions or credit providers in order that they may facilitate other transactions. It should further be appreciated that transactions need not be identified by the prepaid card. Example transactions which do not require the prepaid card include pre-authorized payments such a payments for rental property or utilities.

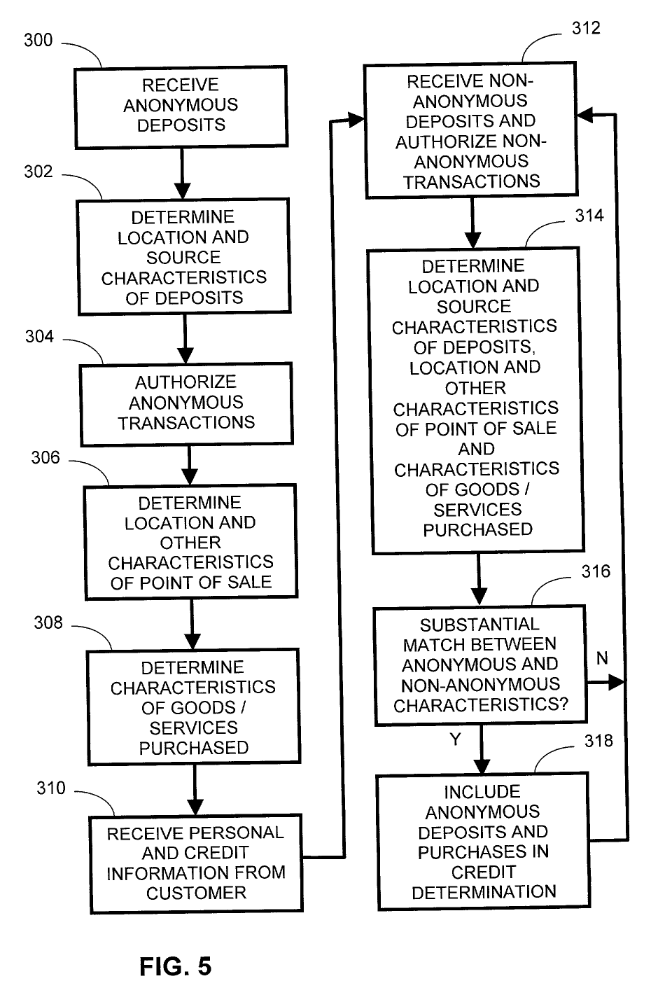

FIG. 5 shows a flow diagram of a process for validating anonymous deposits and purchases prior to provision of personal and credit information for the purpose of credit determination. In this embodiment, anonymous transactions are allowed and tracked, but credit is not extended until after personal and/or other credit information is provided. Anonymous deposits are received at step 300. The location and source characteristics of the deposit are determined at step 302. If cash is deposited at a currency processor, then the location of the currency processor and the amount of the deposit is determined. If another fund transfer method is used, then the source and amount of deposit is determined. In step 304, a transaction is authorized. Step 306 determines the location and other characteristics of the point of sale. The location of the point of sale and deposit location information help to establish a customer's neighborhood. The determination of other characteristics allows determination of the types of stores a consumer shops. Step 308 determines characteristics of goods and services purchased. The aforementioned steps are repeated for all deposits and purchases and help to establish a profile for the anonymous customer. In step 310 the personal and credit information is received from the customer. Step 312 receives deposits and authorizes purchase transactions, albeit with a now non-anonymous customer. Step 314 establishes a profile of the non-anonymous customer by determining the location and source characteristics of non-anonymous deposits and location and other characteristics of points of sale and characteristics of good and/or services purchases. Step 316 allows inclusion of the anonymous deposits of step 300 and anonymous purchases of step 304 at step 318 if the anonymous and non-anonymous characteristics or customer profiles substantially match. Matching profiles include substantially similar profiles that exclude a substantial portion of the population by use of the profiles, thereby reducing the likelihood of theft or fraud. It should be appreciated that step 316 could be modified to weigh the anonymous purchases and deposits on the basis of the similarity between the anonymous and non-anonymous customer profiles. Matching profiles would provide the most weight, while similar profiles, where for example the customer is purchasing goods or services of a slightly different characteristic would reduce the weighing of the anonymous purchases and deposits. Profiles that are completely different may be indicative of theft or fraud and result in no weighing of anonymous purchases and deposits as well as no credit based upon non-anonymous purchases and deposits.

The process of FIG. 5 allows a customer to use a prepaid card to privately conduct transactions with the anonymous nature of cash. After providing information identifying the customer a non-anonymous deposit and purchase profile established. The history established while the customer was anonymous is validated and may be included in a credit determination. This has the advantage of allowing those consumers unworthy of conventional credit and accustom to private and anonymous transactions to smoothly transition to more conventional credit based transactions by allowing their anonymous spending and deposit history to apply to credit determination. This has the further advantage of allowing the individual consumer to decide if and when the anonymous nature of their transactions will be lost and the history applied to credit determination. By comparing anonymous and non-anonymous deposit and purchase profiles, the credit provider has some protection against extending credit based upon fraudulently provided information. Of course, if no anonymous history is available because the customer provides personal and credit information upon receiving the prepaid card, then credit still can be established using the non-anonymous transactions processes of steps 312 through 318.

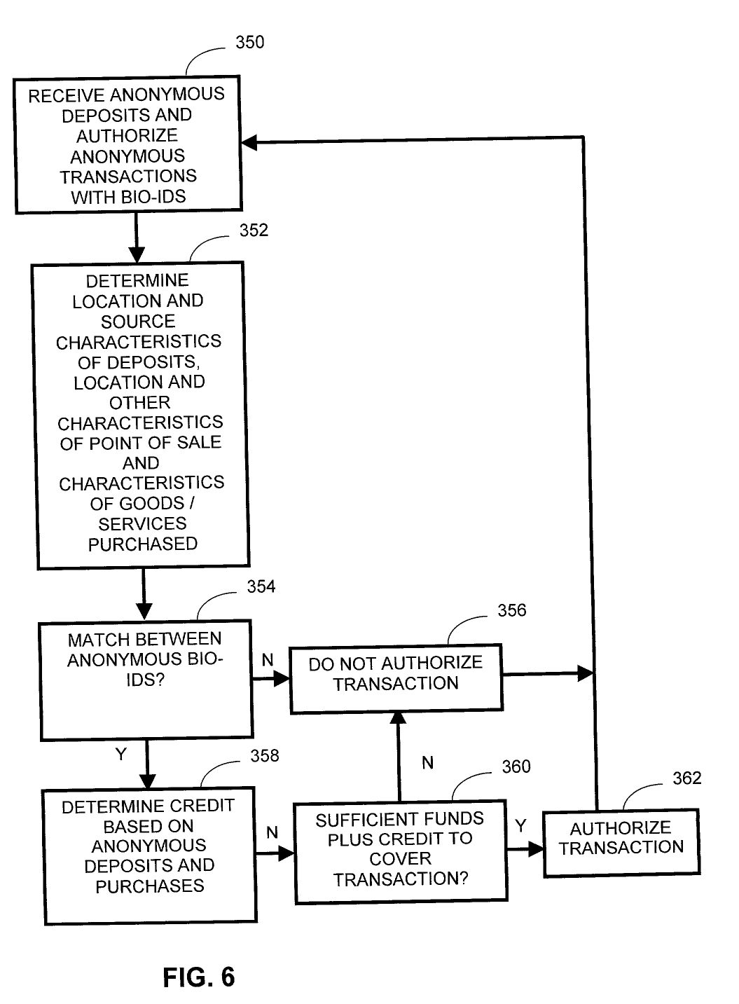

FIG. 6 shows an alternate process for credit extension and transaction validation based on the BIO-ID of the customer. While the process of FIG. 5 in part protects the credit provider from extension of credit due to fraud by validating the anonymous and non-anonymous customer profiles to assure a customer's continuity. The process of FIG. 6 in part protects the credit provider from extension of credit due to fraud or theft by validating the BIO-ID or other biometric indicia of the customer. This is an alternative for or supplement to profile comparisons or other processes for validating anonymous deposits and transactions and has the advantage of not requiring additional personal and/or credit information in the extension of credit. The customer can be positively identified from one transaction to the next as being the same customer, without necessarily knowing the identity of the customer because of a matching BIO-ID. Step 350 receives anonymous deposits, repays loans and authorizes anonymous transactions while processing the associated BIO-IDs. When a customer makes a deposit or a purchase at a consumer point of sale, the BIO-ID is determined by finger print, retinal scan or otherwise thereby validating the customer. Step 352 determines the location and source characteristics of deposits, the location and other characteristics of the point of sale and characteristics of goods and/or services being purchased. Step 354 determines if there is a substantial match identifying the customer between anonymous BIO-IDs of the current transaction with prior purchases and deposits. If no match, the transaction is not authorized at step 358. If there is a match, then step 358 determines a credit limit based on anonymous deposits and purchases. If there are sufficient funds in the account plus the determined credit limit to cover the transaction in step 360 then a loan is granted and the transaction is authorized in step 362. Thus, credit has been extended to a customer who is anonymous yet positively identified as a prior customer.

It should be appreciated that a customer need not be anonymous to use the BIO-ID components of the process of FIG. 6. It should further be appreciated that the anonymous customer has the option to provide personal and credit information at any time. If personal and credit information is provided then loan information and the deposit and spending profile accumulated at step 352 may be made available to other financial institutions and credit providers. The BIO-ID may be used to validate the anonymous profile as belonging to the customer, thereby reducing the risk of fraud or theft in using the previously anonymous information. This eliminates the time and processes of FIG. 5 needed to establish and compare anonymous and non-anonymous profiles in order to validate the non-anonymous profile provided to other financial institutions and credit providers. Alternatively, the processes of profile validation FIG. 5 and/or the BIO-ID validation of FIG. 6 may be combined with other processes to provide further fraud and theft protection.

Thus, what has been provided is a process for extending credit to those receiving cash compensation. What is also provided is a process for extending credit without demanding the loss of privacy facilitated by anonymous cash based transactions.

The present invention, as would be known to one familiar with the art could be produced in hardware or software, or in a combination of hardware and software. The system, or method, according to the inventive principles as disclosed in connection with the preferred embodiment, may be produced in a single computer system having separate elements for performing the individual functions or steps described or claimed or one or more elements combining the performance of any of the functions or steps disclosed or claimed, or may be arranged in a distributed computer system, interconnected by any suitable means as would be known by one familiar with the art.

According to the inventive principles as disclosed in connection with the preferred embodiment, the invention and the inventive principles are not limited to any particular kind of computer system but may be used with any general purpose computer, as would be known to one familiar with the art, arranged to perform the functions described and the method steps described. The operations of such a computer, as described above, may be according to a computer program contained on a medium for use in the operation or control of the computer, as would be known to one familiar with the art. The computer medium which may be used to hold or contain the computer program product, may be a fixture of the computer such as an embedded memory or may be on a transportable medium such as a disk, as would be known to one familiar with the art.

The invention is not limited to any particular computer program or logic or language, or instruction but may be practiced with any such suitable program, logic or language, or instructions as would be known to one familiar with the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

Although a specific embodiment of the invention has been disclosed. It will be understood by those familiar with the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. An automated method of authorizing a consumer purchase comprising the steps of:
receiving a first deposit transaction depositing funds within a first account;
determining a first credit limit associated with the first account wherein the first credit limit is based upon account information associated with the first account;
receiving a request for authorization of a purchase transaction associated with the first account;
authorizing the purchase transaction if funds within the first account plus the first credit limit are to sufficient to facilitate the purchase transaction;
determining a loan amount in response to an amount of the first credit limit utilized for said step of authorizing;
granting a loan in response to the loan amount;
receiving a subsequent deposit transaction having additional funds associated with the first account;
applying a loan repayment portion of the additional funds to at least partial repayment of the loan and transferring a remaining portion of the additional funds to the first account; and
generating credit information indicative of the loan granting and loan repayment.

2. The method of claim 1 wherein the account information consists substantially only of
deposit transaction information,
purchase transaction information,
any loan granting and repayment information, and
any provided personal information indicative of a person associated with the first account
but does not include other financial information related to the person.

3. The method of claim 1 wherein the account information consists substantially only of
deposit transaction information and
personal information indicative of a person associated with the first account
but does not include other financial information related to the person.

4. The method of claim 1 wherein the account information consists substantially only of
deposit transaction information,
purchase transaction information, and
any loan granting and repayment information.

5. The method according to claim 1 wherein the loan repayment portion of the additional funds is a predetermined amount.

6. The method according to claim 1 wherein the loan repayment portion of the additional funds is an amount greater than a predetermined minimum amount wherein the loan repayment porting is indicated by a person associated with the first account.

7. The method according to claim 1 further comprising the steps of:
determining a second credit limit amount associated with a second account substantially independent of the first account in response to the credit information;
receiving a request for authorization of a second purchase transaction associated with the second account; and
authorizing the second purchase transaction if the second credit limit amount is sufficient to facilitate the second purchase transaction.

8. The method according to claim 1 wherein the preceding steps are performed by a first financial institution and the subsequent steps are performed by a second financial institution substantially independent of the first financial institution, the method at the second financial institution comprising the steps of:
determining a second credit limit amount associated with a second account substantially independent of the first account in response to the credit information received from the first financial institution;
receiving a request for authorization of a second purchase transaction associated with the second account; and
authorizing the second purchase transaction if the second credit limit amount is sufficient to facilitate the second purchase transaction.

9. The method according to claim 1 further comprising the steps of:
receiving a plurality of deposit transactions depositing funds into the first account;
authorizing each of a plurality of purchase transactions if funds within the first account are sufficient to facilitate each of the plurality of purchase transactoins; and
including the plurality of deposit transactions and purchase transactions in the account information; wherein
said step of determining the first credit limit determines the first credit limit to be substantially zero upon reception of the first deposit transaction and increases the limit in response to the account information of said step of including.

10. The method according to claim 9 wherein at least a portion of the transactions of said steps of receiving the plurality of deposit transactions and authorizing the plurality of purchase transactions are anonymous, without identification of a person associated with the first account, and the method further comprises the step of:
receiving personal information identifying the person associated with the first account wherein
said step of determining the first credit limit includes account information from the plurality of anonymous deposit and purchase transactions in the determination of the first credit limit.

11. The method according to claim 10 wherein the anonymous deposit transactions include cash deposits received at an automated currency processor using a card having information identifying the first account but not the person, and the anonymous purchase transactions are facilitated by the card having the information identifying the first account but not the person.

12. The method according to claim 10 wherein said step of determining the first credit limit determines the first credit limit to be zero prior to said step of receiving the personal information.

13. The method according to claim 12 further comprising the steps of
validating that the anonymous deposit and purchase transactions where caused by the person associated with the first account, wherein
said step of determining the first credit limit is further responsive to said step of validating.

14. The method according to claim 13 wherein said step of validating further comprises the steps of:
determining an anonymous profile for the deposit and purchase transactions occurring prior to said step receiving personal information;
determining a non-anonymous profile for the deposit and purchase transactions occurring subsequent to said step receiving personal information; and
determination a degree of similarity between the anonymous and non-anonymous profiles.

15. The method according to claim 13 wherein said step of validating further comprises the steps of:
determining an anonymous biological identification of an anonymous person causing deposit and purchase transactions occurring prior to said step receiving personal information;
determining a non-anonymous biological identification of a non-anonymous person causing deposit and purchase transactions occurring subsequent to said step receiving personal information; and
determination a degree of similarity between the anonymous and non-anonymous biological identifications.

16. The method according to claim 1 wherein at least a portion of the loan granting and repayment are anonymous, without identification of a person associated with the first account, and the method further comprises the step of
receiving personal information identifying a person associated with the first account wherein
said step of generating credit information includes anonymous loan and loan repayment information occurring prior to said step receiving personal information.

17. An automated method of authorizing a purchase transaction comprising the steps of:
receiving a plurality of deposits of funds associated with an account;
receiving a request for authorization of a purchase transaction associated with the account from a point of sale; and
authorizing the purchase transaction if the account has sufficient funds to facilitate the purchase transaction; or
authorizing the purchase transaction
if the account has insufficient funds to facilitate the purchase transaction, and upon
determining that the plurality of deposits satisfy a predetermined criterion; or
otherwise not authorizing the purchase transaction.

18. The method according to claim 17 wherein a person is associated with the account and the method further comprises the step of
receiving additional information indicative of the person, wherein
said step of determining that the plurality of deposits satisfies the predetermined criterion further comprises the step of evaluating the additional information.

19. The method according to claim 18 further comprising the steps of:
granting a loan associated with the account in response to said step of determining that the plurality of deposits satisfy a predetermined criterion; and
providing financial information regarding the granting of the loan to a financial institution substantially unrelated to said step of determining that the plurality of deposits satisfy the predetermined criterion.

20. The method according to claim 18 further comprising the steps of:
granting a loan associated with the account in response to said step of determining that the plurality of deposits satisfy a predetermined criterion;
receiving a subsequent deposit associated with the account subsequent to said step of granting the loan;
applying at least a portion of the subsequent deposit to at least partial repayment of the loan; and
providing financial information regarding the granting of the loan a financial institution substantially unrelated to said step of determining that the plurality of deposits satisfy the predetermined criterion.

21. The method according to claim 20 wherein said step of receiving the plurality of deposits further comprises the steps of:
receiving at least an anonymous initial deposit of the plurality of deposits of funds associated with the account prior to said step of receiving additional information indicative of the person; and
receiving at least a non-anonymous subsequent deposit of the plurality of deposits of funds associated with the account subsequent to said step of receiving additional information indicative of the person, wherein
said step of determining that the plurality of deposits satisfies the predetermined criterion evaluates both the anonymous initial deposit and the non-anonymous subsequent deposit.

22. The method according to claim 21 further comprising the step of
authorizing at least one prior purchase transaction from at least one prior point of sale prior to said step of receiving additional credit information indicative of the person wherein the point of sale and the prior point of sale each have at least one distinguishing characteristic and further wherein
said step of determining that the plurality of deposits satisfies the predetermined criterion further includes the step of
determining a correspondence between the at least one distinguishing characteristic of the point of sale and the prior point of sale.

23. The method according to claim 17 wherein a person is associated with the account and the person has a biological identification trait indicative of the person and further wherein
said step of receiving a plurality of deposits further includes the step of receiving a biological identification signal indicative of a person causing each deposit,
said step of receiving the request for authorization further includes the step of receiving a biological identification signal indicative of a person causing each request for authorization, and
said step of determining further determines that each of the biological identification signals substantially match prior to authorizing the transaction.

24. The method according to claim 23 wherein the person providing substantially matching biological identification signals is anonymous and substantially no additional personal information is used to authorize the purchase transaction if the account has insufficient funds.

25. The method according to claim 17 wherein the plurality of deposits consist substantially only of cash deposits received at an automated currency processor.

26. The method according to claim 17 wherein the plurality of deposits include deposits from an employer of a person associated with the account.

27. The method according to claim 17 wherein the plurality of deposits include deposits from an employer of a person associated with the account and cash deposits received at an automated currency processor.

28. The method according to claim 17 wherein said step of receiving the plurality of deposits further includes:
receiving cash deposits received at an automated currency processor
reading identification information from an account card at the automated currency processor; and
associating the cash deposit with the account in response thereto, and further wherein said step of receiving the request for authorization further includes the steps of:
reading identification information from the account card at the point of sale; and
associating the purchase transaction with the account in response thereto.

29. The method according to claim 28 wherein no person information is associated with the account card.

30. The method according to claim 28 wherein personal information indicative of a person is associated with the account card but no substantial steps are taken to validate the personal information.

31. The method according to claim 17 wherein at least a portion of the plurality of deposits are regularly received from a transferring entity and said step of determining that the plurality of deposits satisfies the predetermined criterion further comprises the step of analyzing a viability of the transferring entity to facilitate a deposit at a next expected regularly received deposit.

32. The method according to claim 17 wherein said step of determining that the plurality of deposits satisfies the predetermined criterion includes determining a number, frequency and magnitude of the deposits.

33. The method according to claim 17 wherein said step of determining that the plurality of deposits satisfies the predetermined criterion further comprises the step of determining a classification for the point of sale.

34. The method according to claim 17 wherein said step of determining that the plurality of deposits satisfies the predetermined criterion further comprises the steps of:
determining prior classifications based upon prior points of sale;
determining a current classification for the point of sale; and
comparing the classification with the prior classifications, wherein the transaction is authorized in response to a current degree of a similarity there between.

35. The method according to claim 17 wherein a person is associated with the card and additional credit information is provided by the person, and said step of determining that the plurality of deposits satisfies the predetermined criterion further comprises the step of evaluating the additional credit information.

36. A method of determining a credit limit comprising the steps of:
receiving a plurality of deposits associated with an account;
determining a number, frequency and magnitude of the deposits; and
assigning a credit limit for the account in response to said step of determining.

37. The method according to claim 36 wherein at least a portion of the plurality of deposits are cash deposits received at an automated currency processing device.

38. The method according to claim 36 further comprising the steps of:
determining a credit rating in response to said step of determining; and
providing the credit rating to a financial institution substantially unrelated to said step of assigning.

39. The method according to claim 36 further comprising the steps of:
granting a loan associated with the account on the basis of the assigned credit limit; and
providing information regarding the granting of the loan to a financial institution substantially unrelated to said steps of assigning and granting.

40. The method according to claim 36 further comprising the steps of:
granting a loan associated with the account on the basis of the assigned credit limit;
receiving a subsequent deposit associated with the account subsequent to said step of granting the loan;
applying at least a portion of the subsequent deposit to at least partial repayment of the loan; and
providing information regarding the at least partial repayment of the loan to a financial institution substantially unrelated to said steps of assigning and granting.

41. The method according to claim 36 wherein at least a portion of the plurality of deposits are regularly received from a transferring entity and the method further comprises the step of
analyzing a viability of the transferring entity at a next expected regular deposit, and wherein
said step assigning assigns the credit limit further in response to said step of analyzing.

42. The method according to claim 36 further comprising the steps of:
receiving a purchase transaction authorization request associated with the account from a point of sale; and
determining at least one characteristic associated with the point of sale, wherein
said step assigning adjusts the credit limit in response to the characteristic.

43. The method according to claim 36 wherein at least one deposit of the plurality of deposits an anonymous deposit, received without having received identification of a person associated with the account, and the method further comprises the step of
receiving personal information identifying the person associated with the account wherein
said step of assigning further assigns the credit limit in response to the at least one anonymous deposit.

44. The method according to claim 43 further comprising the step of
validating that the anonymous deposit was substantially likely received from the person associated with the account, wherein
said step assigning only uses the at least one anonymous deposit in assigning the credit limit in response to said step of validating.

45. The method according to claim 44 wherein said step of validating further comprises the steps of:
determining an anonymous profile for the at least one anonymous deposit; and
determining a non-anonymous profile for deposits received subsequent to said step receiving personal information,
wherein the at least one anonymous deposit is validated in response to a substantial similarity between the anonymous and non-anonymous profiles.

46. The method according to claim 44 wherein said step of validating further comprises the steps of:
determining an anonymous biological identification of an anonymous person causing the at least one anonymous deposit; and
determining a non-anonymous biological identification of a non-anonymous person causing deposits received subsequent to said step receiving personal information,
wherein the at least one anonymous deposit is validated in response to a substantial similarity between the anonymous and non-anonymous biological identifications.

47. A method of determining a credit limit for an account comprising the steps of:
receiving a plurality of transaction requests having transaction information related to characteristics of each of a plurality of points of sale associated with the account;
authorizing each transaction request in response to sufficient funds being associated with the account;
associating a quality factor to each of the plurality of points of sale in response to the characteristics; and
assigning the credit limit for the account in response to the quality factors of each of the plurality of points of sale.

48. The method according to claim 47 further comprising the steps of:
assigning a credit risk factor for the account in response to the quality factors of each of the plurality of points of sale; and
providing the credit risk factor to a financial institution substantially unrelated to said step of assigning.

49. The method according to claim 47 further comprising the steps of:
receiving a plurality of deposits associated with the account; and
determining a number, frequency and magnitude of the deposits; wherein
said step of assigning further assigns the credit limit for the account in response to said step of determining.

50. The method according to claim 47 further comprising the steps of:
granting a loan associated with the account in response to one of the plurality or transaction requests being from one of the plurality of points of sale and further in response to insufficient funds being associated with the account and on the basis of the credit limit;
authorizing the transaction in response to said step of granting the loan; and
providing information regarding the granting of the loan to a financial institution substantially unrelated to said steps of assigning and granting.

51. The method according to claim 47 wherein at least one of the plurality of transaction requests is an anonymous transaction, received without having received identification of a person associated with the account, and the method further comprises the step of
receiving personal information identifying the person associated with the account wherein
said step of assigning further assigns the credit limit in response to the at least one anonymous transaction.

52. The method according to claim 51 further comprising the step of
validating that the at least one anonymous transaction was substantially likely received from the person associated with the account, wherein
said step assigning only uses the at least one anonymous transaction for assigning the credit limit in response to said step of validating.

53. The method according to claim 52 wherein said step of validating further comprises the steps of:
determining an anonymous profile for the at least one anonymous transaction;
determining a non-anonymous profile for transactions received subsequent to said step receiving personal information; and
wherein the at least one anonymous transaction is validated in response to a substantial similarity between the anonymous and non-anonymous profiles.

54. The method according to claim 52 wherein said step of validating further comprises the steps of:
determining an anonymous biological identification of an anonymous person causing the at least one anonymous transaction;
determining a non-anonymous biological identification of a non-anonymous person causing transactions received subsequent to said step receiving personal information; and
wherein the at least one anonymous transaction is validated in response to a substantial similarity between the anonymous and non-anonymous biological identifications.
